(19) United States
(12) Patent Application Publication
(10) Pub. No.: US 2012/0051542 A1
(43) Pub. Date: Mar. 1, 2012

(54) REMOTE COMMUNICATION APPARATUS INCLUDING SECURITY FUNCTION AND REMOTE ELECTRIC POWER METERING SYSTEM USING THE SAME

(75) Inventors: Min Gyu KIM, Incheon (KR); Young Jin HAN, Yongin (KR)

(73) Assignee: SAMSUNG ELECTRO-MECHANICS CO., LTD., Gyunggi-do (KR)

(21) Appl. No.: 13/028,436

(22) Filed: Feb. 16, 2011

(30) Foreign Application Priority Data
Aug. 25, 2010 (KR) 10-2010-0082673

(51) Int. Cl. H04K 1/00

(52) U.S. Cl. 380/255

(57) ABSTRACT

There are provided a remote communication apparatus including a security function and a remote electric power metering system using the same. The remote communication apparatus including a security function includes: a security algorithm application unit decrypting a receiving signal received from a communication network in the case in which the receiving signal is an encrypted signal and encrypting a transmitting signal to be transmitted to the communication network; and a protocol unit converting the receiving signal or the receiving signal decrypted by the security algorithm application unit according to a preset communication protocol and generating the transmitting signal according to the preset communication protocol.

### CROSS-REFERENCE TO RELATED APPLICATIONS

This application claims the priority of Korean Patent Application No. 10-2010-0082673 filed on Aug. 25, 2010, in the Korean Intellectual Property Office, the disclosure of which is incorporated herein by reference.

### BACKGROUND OF THE INVENTION

1. Field of the Invention

The present invention relates to a remote metering technology, and more particularly, to a remote communication apparatus including a security function and a remote electric power metering system using the same.

2. Description of the Related Art

With reference to a Smart Grid which has been recently been prominent, an electronic watt hour meter has been actively developed in order to efficiently utilize electric power and monitor the use of electric power in an advanced form.

Currently, a number of electric power companies including Korea Electric Power Corporation use a Device Language Message Specification (DLMS) protocol, which is an International Communication Protocol specification, for remote metering with reference to the spread of the electronic watt hour meter. However, an existing electronic watt hour meter using the DLMS protocol has security related problems such as the manipulation and changing of data through a communication line between the electronic watt hour meter and a remote metering apparatus.

In other words, all of the data transmitted and received using the DLMS protocol is comprised of raw data capable of being analyzed without performing a separate processing thereon. Accordingly, the existing electronic watt hour meter is weak in terms of security, since the raw data may be manipulated and changed through intervention in the communication line between the electronic watt hour meter and the remote metering apparatus for a malicious purpose. For example, in the case that any terminal apparatus is connected to the communication line between the electronic watt hour meter and the remote metering apparatus to change and transmit an effective electric power amount value, which is one of a plurality of metered items, to the remote metering apparatus, there was a problem in that the electric power company such as Korea Electric Power Corporation charges a fee for an amount of electric power less than the amount of electric power actually used.

### SUMMARY OF THE INVENTION

An aspect of the present invention provides a remote communication apparatus including a security function capable of solving a security related problem such as the manipulation and changing of data, and a remote electric power metering system using the same.

According to an aspect of the present invention, there is provided a remote communication apparatus including a security function, including: a security algorithm application unit decrypting a receiving signal received from a communication network in the case in which the receiving signal is an encrypted signal and encrypting a transmitting signal to be transmitted to the communication network; and a protocol unit converting the receiving signal or the receiving signal decrypted by the security algorithm application unit according to a pre-set communication protocol and generating the transmitting signal according to the pre-set communication protocol.

The remote communication apparatus may further include a signal selection unit providing the receiving signal to the protocol unit in the case in which the receiving signal is a non-encrypted signal and selectively providing the transmitting signal generated in the protocol unit to the security algorithm application unit or a communication modem unit.

According to another aspect of the present invention, there is provided a remote electric power metering system including a security function, including: a remote metering unit including a application unit including an application for remote metering, a first protocol unit applying a Device Language Message Specification (DLMS) protocol to first data to be transmitted from the first application unit to a remote watt hour meter and second data transmitted from the remote watt hour meter to the first application unit, and a security algorithm application unit selectively encrypting the first data according to the DLMS protocol and decrypting the second data in the case in which the second data are encrypted data; a first communication modem unit transmitting the first data from the remote metering unit to a communication network and receiving the second data from the communication network to provide the second data to the remote metering unit; the remote watt hour meter including a second application unit including an application for measurement of electric power amount, receiving the first data and generating the second data, a second protocol unit applying the DLMS protocol to the first and second data, and a security algorithm application unit selectively encrypting the second data according to the DLMS protocol and decrypting the first data in the case in which the first data are encrypted data; and a second communication modem unit transmitting the second data from the remote watt hour meter to the communication network and receiving the first data from the communication network to provide the first data to the remote watt hour meter.

The remote metering unit may further include a first signal selection unit receiving the second data directly from the first communication modem unit to provide the second data to the first protocol unit in the case in which the second data received from the first communication modem unit are non-encrypted signals, and providing the first data to which the DLSM protocol is applied to the first security algorithm application unit or the first communication modem unit.

Similarly, the remote watt hour meter may further include a second signal selection unit receiving the first data directly from the second communication modem unit to provide the first data to the second protocol unit in the case in which the first data received from the second communication modem unit are non-encrypted signals, and providing the second data to which the DLSM protocol is applied to the second security algorithm application unit or the second communication modem unit.

The remote metering unit may transmit an encryption response setting message to the remote watt hour meter and receives a response ready message for the encryption response setting message from the remote watt hour meter to perform encryption communication.

The remote metering unit may make one of object identification system (OBIS) codes supported by the DLMS protocol a code for confirming encryption support to transmit the code to the remote watt hour meter, and the remote watt hour meter may inform the remote metering unit that the encryption communication may be performed in the case in which the remote watt hour meter has the code for confirming encryption support in advance, such that the encryption communication between the remote metering unit and the remote watt hour meter is performed.

According to the present invention, since the encryption communication between the electronic watt hour meter and the remote meterting apparatus may be performed, a problem associated with security such as the manipulation and changing of data may be solved and the remote metering of the electronic watt hour meter may be securely performed.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram showing a configuration of a remote communication apparatus including a security function and a remote electric power metering system implemented by the remote communication apparatus according to an exemplary embodiment of the present invention; and

FIGS. 2 and 3 are timing diagrams showing an operating method of a remote electric power metering system including a security function according to an exemplary embodiment of the present invention.

### DETAILED DESCRIPTION OF THE PREFERRED EMBODIMENT

Hereinafter, various exemplary embodiments of the present invention will be described with reference to the accompanying drawings. However, the exemplary embodiments of the present invention may be modified in many different forms and the scope of the invention should not be limited to the embodiments set forth herein. Rather, these exemplary embodiments are provided so that this disclosure will be thorough and complete, and will fully convey the concept of the invention to those skilled in the art. Therefore, it is to be noted that the shape and size of components shown in the drawings can be exaggerated in order to provide more clear description.

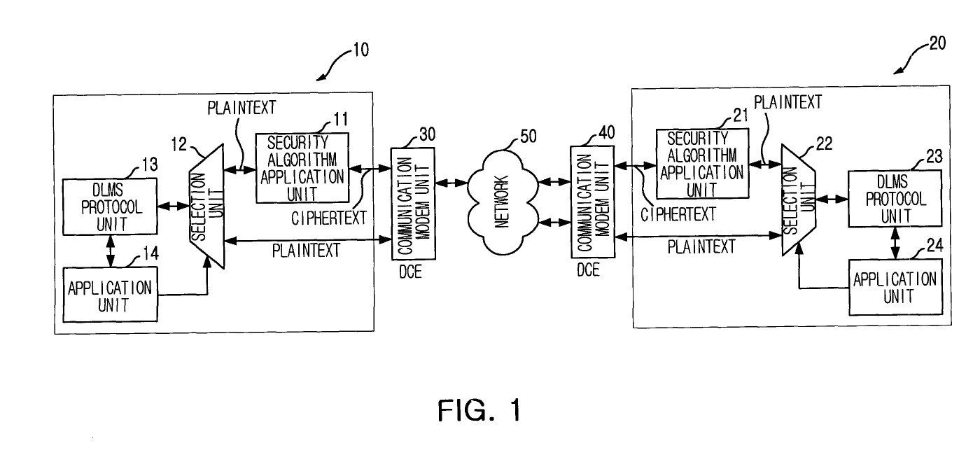

FIG. 1 is a block diagram showing a configuration of a remote communication apparatus including a security function and a remote electric power metering system implemented by the remote communication apparatus according to an exemplary embodiment of the present invention.

Referring to FIG. 1, remote communication apparatuses 10 and 20 including a security function according to an exemplary embodiment of the present invention may be used in a remote electric power metering system including the security function.

The remote communication apparatuses 10 and 20 including the security function according to the exemplary embodiment of the present invention may include security algorithm application units 11 and 21 and protocol units 13 and 23. In addition, the remote communication apparatuses 10 and 20 including the security function according to the exemplary embodiment of the present invention may further include signal selection units 12 and 22.

The security algorithm application units 11 and 21 decrypt receiving signals received from an external communication network 50 in the case in which the receiving signals are encrypted signals and encrypt transmitting signals to be transmitted to the external communication network to output the transmitting signals to the outside of the remote communication apparatuses 10 and 20. For example, the security algorithm application units 11 and 21 may encrypt the transmitting signals by applying a security algorithm such as an AES (Advanced Encryption Standard) algorithm thereto and decrypt the encrypted receiving signals through the AES algorithm.

The protocol units 13 and 23 may convert or generate the receiving signal and the transmitting signal according to a communication protocol. In the case in which the remote communication apparatuses 10 and 20 according to the exemplary embodiment of the present invention to a remote metering field, the protocol units 13 and 23 may apply a Device Language Message Specification (DLMS) protocol. The DLMS protocol is an International Standard of International Electrotechnical Commission (IEC) for remote metering. The DLMS protocol defines a method for modeling various pieces of data treated by an electric meter as logical objects in order to ensure interoperability, defining the modeled data as a data message in a standardized data structure and transmitting the data message to a variety of types of transmission media.

In order to selectively apply the security algorithm to the transmitting signals output from the protocol units 13 and 23, the signal selection units 12 and 22 may provide the transmitting signals to which the security algorithm needs to be applied to the security algorithm application unit 11 and output the transmitting signals to which the security algorithm needs riot to be applied directly to the outside of the remote communication apparatuses 10 and 20. Also, the signal selection units 12 and 22 may transfer the signals not required to be decrypted among the receiving signals directly to the protocol units 12 and 23.

In FIG. 1, communication modem units 30 and 40 modulate and demodulate signals output from each of the remote communication apparatuses 10 and 20 so that the signals may be transferred through the communication network 50. Also, the application units 14 and 24 included in each of the remote communication apparatuses 10 and 20 perform a proper function for use of the respective communication apparatuses. For example, in the case in which the remote communication apparatus 10 is used for remote metering, the application unit 14 may perform a function such as generation of data request signals, analysis of collected data, aggregation of the collected data, creation of statistics, and the like, required for remote metering. Also, in the case in which the remote communication apparatus 20 is used as a watt hour meter, the application unit 24 may detect and store an amount of used electric power (effective electric power, reactive electric power, and the like) using voltage and current detected from an electric power line.

As shown in FIG. 1, the remote communication apparatuses 10 and 20 as set forth above may be used in the remote electric power, metering system including the security function. The remote electric power metering system including the security function will be described with reference to FIG. 1.

In the remote electric power metering system according to the exemplary embodiment of the present invention, one of the remote communication apparatuses becomes a remote metering unit 10 and the other becomes a remote watt hour meter 20. Also, the remote electric power metering system according to the exemplary embodiment of the present invention may include first and second communication modem units 30 and 40 so that the remote metering unit 10 and the remote watt hour meter 20 may be communicated with each other using the communication network 50.

The remote metering unit 10 may include a first application unit 14 including an application for remote metering, a first protocol unit 13 applying a Device Language Message Specification (DLMS) protocol to first data to be transmitted from the first application unit 14 to the remote watt hour meter 20 and second data transmitted from the remote watt hour meter 20 to the first application unit 14, and a security algorithm application unit 11 selectively encrypting the first data according to the DLMS protocol and decrypting the second data in the case in which the second data are encrypted data.

In addition, the remote metering unit 10 may further include a first signal selection unit 12 receiving the second data directly from the first communication modem unit 30 to provide the second data to the first protocol unit 13 in the case in which the second data received from the first communication modem unit 30 are non-encrypted signals, and providing the first data to which the DLSM protocol is applied to the first security algorithm application unit 11 or the first communication modem unit.

The remote watt hour meter 20 may include a second application unit 24 including an application for measurement of electric power amount, receiving the first data and generating the second data, a second protocol unit 23 applying the DLMS protocol to the first and second data, and a security algorithm application unit 21 selectively encrypting the second data according to the DLMS protocol and decrypting the first data in the case in which the first data are encrypted data.

In addition, the remote metering unit 20 may further include a second signal selection unit 22 receiving the first data directly from the second communication modem unit 40 to provide the first data to the second protocol unit 23 in the case in which the first data received from the second communication modem unit 40 are non-encrypted signals, and providing the second data to which the DLSM protocol is applied to the second security algorithm application unit 21 or the second communication modem unit.

The first communication modem unit 30 may transmit the first data from the remote metering unit 10 to the communication network 50 and receive the second data from the communication network 50 to provide the second data to the remote metering unit 10.

Similarly, the second communication modem unit 40 may transmit the second data from the remote watt hour meter 20 to the communication network 50 and receive the first data from the communication network 50 to provide the first data to the remote watt hour meter 20.

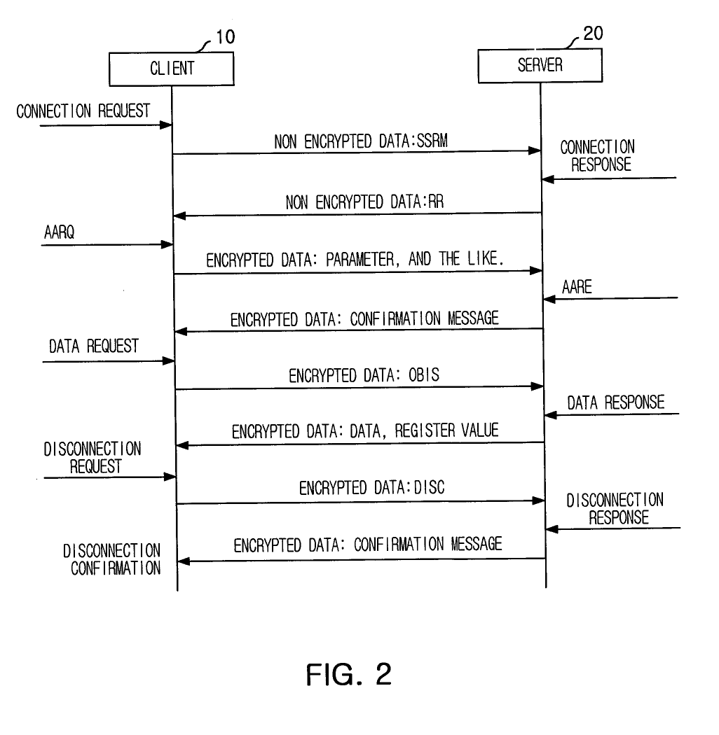

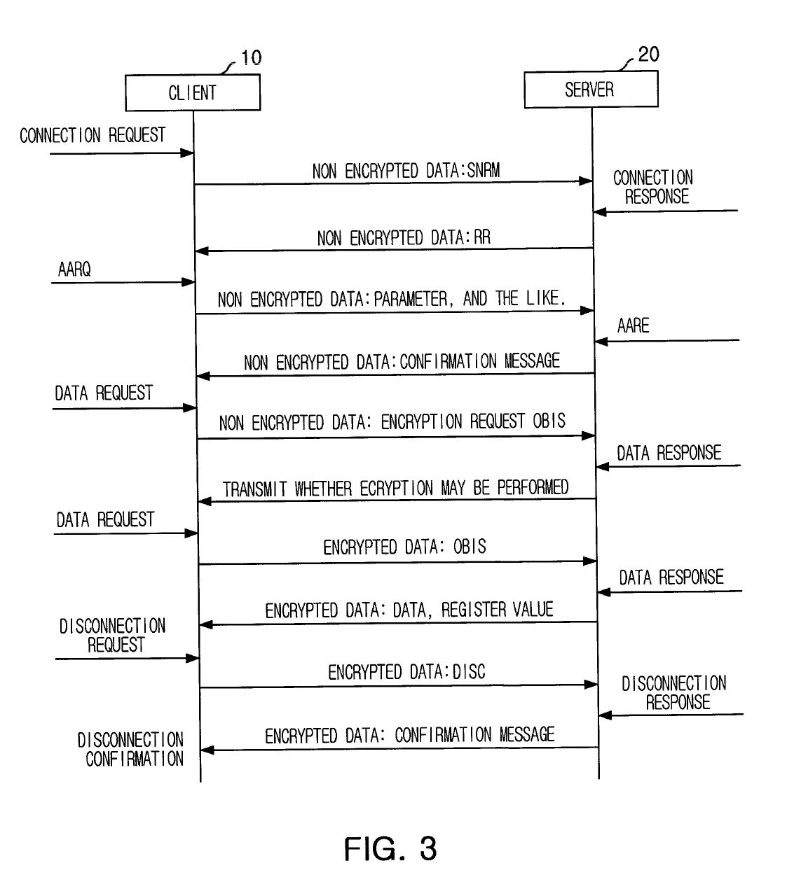

FIGS. 2 and 3 are timing diagrams showing an operating method of a remote electric power metering system including a security function according to an exemplary embodiment of the present invention.

Hereinafter, the operating method of the remote electric power metering system according to the exemplary embodiment of the present invention will be described in detail.

First, referring to FIG. 2, when connection request occurs from a client 10, that is, the remote metering unit, a message inquiring whether encryption communication may be performed is transmitted using non-encrypted data (SSRM: set secure response mode) from the first application unit 14 to a server 20, that is, the remote watt hour meter through the first signal selection unit 12 and the first communication modem unit 30. Then, in response to the transmission, the second application unit 24 of the server 20 transmits a response ready message in a non-encrypted state (RR: response ready) to the client 10 through the second signal selection unit 22 and the second communication modem unit 40.

Next, when an application association request (AARQ) occurs, the encrypted data, that is, parameter messages passing through the first protocol unit 13, the first signal selection unit 12 and the first security algorithm application unit 11 are transmitted from the client 10 to the server 20. The server 20 decrypts the parameter message for connecting the client 10 to the server 10, received from the client 10, and encrypts a confirmation message for the parameter message to transmit the message to the client 10. That is, the server 20 transmits the confirmation message through the second protocol unit 23, the second signal selection unit 22 and the second security algorithm application unit 21 to the client 10.

Then, the client 10 encrypts an object identification system (OBIS) code supported by the DLMS protocol to request data. In response to the request, the server 20 transmits encrypted data, register values, and the like to the client 10.

Next, the client 10 having received all required information requests disconnection (DISC) using encrypted data, and the server 20 transmits a response to the request using the encrypted data to the client 10 such that the communication between the remote metering unit and the remote watt hour meter ends.

FIG. 3 shows a security communication method in a different form from FIG. 2. Referring to FIG. 3, first, the client 10 requests a normal response mode, that is, a non-encrypted response mode (SRNM: set normal response mode) using non-encrypted data, and the server 20 responds to the request using a non-encrypted message (RR: response ready).

Then, the client 10 transmits parameters required for communication to the server 20 using the non-encrypted data, and the server responds to the transmission using a non-encrypted confirmation message, such that connection between the client 10 and the server 20 is established.

Next, the client 10 transmits the OBIS code requesting the encryption communication to the server 20 in a non-encrypted state. The OBIS code has a structure in which if a new function is added, the new function may be supported. In an embodiment in FIG. 3, a code emptied in the OBIS code is used as a code requesting encryption in order to extend the new function. If the server 20 has the OBIS code associated with encryption, it performs data response that the encryption communication may be performed. However, in the case in which the server 20 may not perform the encryption communication, it performs the communication in a non-encryption mode.

Then, in the case in which the encryption communication may be performed, the client 10 encrypts the object identification system (OBIS) code supported by the DLMS protocol to request the data. In response to the request, the server 20 transmits the encrypted data, register values, and the like to the client 10.

Next, the client 10 having received all required information requests disconnection (DISC) using the encrypted data, and the server 20 transmits a response to the request using the encrypted data to the client 10, such that the communication between the remote metering unit and the remote wart hour meter ends.

As shown in FIGS. 2 and 3, the present invention may be implemented as a method for performing the encryption communication by transmitting and receiving separate encryption messages and a method for performing the encryption communication by requesting the encryption using the OBIS code supported by the DLMS protocol.

As set forth above, according to exemplary embodiments of the invention, since the encryption communication between the electronic watt hour meter and the remote metering apparatus may be performed, a problem associated with security such as manipulation and change of data may be solved and the remote metering of the electronic electric watt hour meter may be securely performed.

While the present invention has been shown and described in connection with the exemplary embodiments, it will be apparent to those skilled in the art that modification and variation can be made withough departing from the spirit and scope of the invention as defined by the appended claims.

What is claimed is:

1. A remote communication apparatus including a security function, comprising:
a security algorithm application unit decrypting a receiving signal received from a communication network in the case in which the receiving signal is an encrypted signal and encrypting a transmitting signal to be transmitted to the communication network; and
a protocol unit converting the receiving signal or the receiving signal decrypted by the security algorithm application unit according to a pre-set communication protocol and generating the transmitting signal according to the pre-set communication protocol.

2. The remote communication apparatus including a security function of claim 1, further comprising a signal selection unit providing the receiving signal to the protocol unit in the case in which the receiving signal is a non-encrypted signal and selectively providing the transmitting signal generated in the protocol unit to the security algorithm application unit or a communication modem unit.

3. A remote electric power metering system including a security function, comprising:
a remote metering unit including a first application unit including an application for remote metering, a first protocol unit applying a Device Language Message Specification (DLMS) protocol to first data to be transmitted from the first application unit to a remote watt hour meter and second data transmitted from the remote watt hour meter to the first application unit, and a security algorithm application unit selectively encrypting the first data according to the DLMS protocol and decrypting the second data in the case in which the second data are encrypted data;
a first communication modem unit transmitting the first data from the remote metering unit to a communication network and receiving the second data from the communication network to provide the second data to the remote metering unit;
the remote watt hour meter including a second application unit including an application for measurement of electric power amount, receiving the first data and generating the second data, a second protocol unit applying the DLMS protocol to the first and second data, and a security algorithm application unit selectively encrypting the second data according to the DLMS protocol and decrypting the first data in the case in which the first data are encrypted data; and
a second communication modem unit transmitting the second data from the remote watt hour meter to the communication network and receiving the first data from the communication network to provide the first data to the remote watt hour meter.

4. The remote electric power metering system including a security function of claim 3, wherein the remote metering unit further includes a first signal selection unit receiving the second data directly from the first communication modem unit to provide the second data to the first protocol unit in the case in which the second data received from the first communication modem unit are non-encrypted signals, and providing the first data to which the DLSM protocol is applied to the first security algorithm application unit or the first communication modem unit.

5. The remote electric power metering system including a security function of claim 3, wherein the remote watt hour meter further includes a second signal selection unit receiving the first data directly from the second communication modem unit to provide the first data to the second protocol unit in the case in which the first data received from the second communication modem unit are non-encrypted signals, and providing the second data to which the DLSM protocol is applied to the second security algorithm application unit or the second communication modem unit.

6. The remote electric power metering system including a security function of claim 3, wherein the remote metering unit transmits an encryption response setting message to the remote watt hour meter and receives a response ready message for the encryption response setting message from the remote watt hour meter to perform encryption communication.

7. The remote electric power metering system including a security function of claim 3, wherein the remote metering unit makes one of object identification system (OBIS) codes supported by the DLMS protocol a code for confirming encryption support to transmit the code to the remote watt hour meter, and the remote watt hour meter informs the remote metering unit that the encryption communication is performed in the case in which the remote watt hour meter has the code for confirming encryption support in advance, such that the encryption communication between the remote metering unit and the remote watt hour meter is performed.
